(19) United States
(12) Patent Application Publication
(10) Pub. No.: US 2016/0342951 A1
(43) Pub. Date: Nov. 24, 2016

(54) METHOD, SYSTEM, AND NON-TRANSITORY COMPUTER-READABLE RECORDING MEDIUM FOR PROVIDING NOTIFICATION ON SCHEDULE

(71) Applicant: KONOLABS, INC, Seoul (KR)

(72) Inventors: Jung Hee Ryu, Seoul (KR); Yun Jeong Min, Seoul (KR); Min Cheol Song, Seoul (KR)

(21) Appl. No.: 14/875,780

(22) Filed: Oct. 6, 2015

(30) Foreign Application Priority Data
May 20, 2015 (KR) 10-2015-0070229

(51) Int. Cl. G06Q 10/10; H04L 29/08

(52) U.S. Cl. CPC G06Q 10/1095; H04L 67/306; H04L 67/22

(57) ABSTRACT

According to one aspect of the present invention, there is provided a method for providing notifications on schedule, comprising the steps of: selecting at least one event requiring a notification from among events included in a user's schedule; dynamically determining at least one of a notification generation option, a notification generation time, a notification content, a task according to the notification, and a notification recipient of the at least one selected event, with reference to context information for generation of the notification; and generating the notification of the event whose notification is determined to be generated, with reference to the determined at least one of the notification generation time, the notification content, the task according to the notification, and the notification recipient.

### CROSS-REFERENCE TO RELATED APPLICATION

This application claims priority to and the benefit of Korean Patent Application No. 10-2015-0070229 filed in the Korean Intellectual Property Office on May 20, 2015, the entire contents of which are incorporated herein by reference.

### BACKGROUND OF THE INVENTION

(a) Field of the Invention

The present invention relates to a method, system, and non-transitory computer-readable recording medium for providing notifications on schedule.

(b) Description of the Related Art

In order to create a new event in conventional calendar programs (or applications), a user should personally find an empty time slot on a timetable, and manually enter specific information on the event one by one, such as a task, location, start time, end time, recurrence, upcoming event notification generation time, etc. For this reason, a problem occurs in that it takes a great deal of time and effort for the user to manage schedule. Although there are various calendar programs that have been recently developed, these programs simply differ in terms of exterior elements such as designs or titles, and basically have the same problems as above.

Further, the conventional calendar programs only provide schedule management functionality for a single user, and thus, when managing an event involving two or more users, the users cannot avoid the inconvenience of personally contacting each user separately from the calendar programs to decide on a time or location of the event together, and entering information on the decided time or location of the event into the calendar programs, one by one.

Meanwhile, in order to address the aforementioned drawbacks of the conventional calendar programs, some programs have been introduced to support easy management of to-do lists. These to-do list management programs may function to allow a user to conveniently enter and organize tasks and to check the completion of the tasks. However, these programs do not take into account respective task durations or other events included in the user's schedule, and are not, therefore, suitable to be used as programs for generally managing the user's schedule.

Moreover, the conventional calendar programs usually send event notifications (i.e., reminders) at user-specified times in the form of push notification, email, or the like. It is quite time-consuming and inconvenient for the user to specify each notification generation time for every event registered on the schedule.

In this connection, the present inventor(s) suggest a technique for providing a situation-dependent notification by adaptively determining an event notification generation option, a notification generation time, a notification content, a task according to the notification, or a notification recipient, depending on the situation.

The above information disclosed in this Background section is only for enhancement of understanding of the background of the invention and therefore it may contain information that does not form the prior art that is already known in this country to a person of ordinary skill in the art.

### SUMMARY OF THE INVENTION

One object of the present invention is to solve all of the above-described problems in prior art.

Another object of the present invention is to provide a situation-dependent notification by adaptively determining an event notification generation option, a notification generation time, a notification content, a task according to the notification, or a notification recipient, depending on the situation, by selecting at least one event requiring a notification from among events included in a user's schedule, dynamically determining a notification generation option, a notification generation time, a notification content, a task according to the notification, or a notification recipient of the at least one selected event with reference to context information for generation of the notification, and generating the notification of the event whose notification is determined to be generated, with reference to the notification generation time, the notification content, the task according to the notification, or the notification recipient determined as above.

The representative configurations of the present invention for achieving the above-described objects are as follows.

According to one aspect of the present invention, there is provided a method for providing notifications on schedule, comprising the steps of: selecting at least one event requiring a notification from among events included in a user's schedule; dynamically determining at least one of a notification generation option, a notification generation time, a notification content, a task according to the notification, and a notification recipient of the at least one selected event, with reference to context information for generation of the notification; and generating the notification of the event whose notification is determined to be generated, with reference to the determined at least one of the notification generation time, the notification content, the task according to the notification, and the notification recipient.

According to another aspect of the present invention, there is provided a system for providing notifications on schedule, comprising: an event manager for selecting at least one event requiring a notification from among events included in a user's schedule; and a notification provider for dynamically determining at least one of a notification generation option, a notification generation time, a notification content, a task according to the notification, and a notification recipient of the at least one selected event, with reference to context information for generation of the notification, and generating the notification of the event whose notification is determined to be generated, with reference to the determined at least one of the notification generation time, the notification content, the task according to the notification, and the notification recipient.

In addition, there are further provided other methods and systems for implementing the present invention, as well as non-transitory computer-readable recording media for storing computer programs for executing the above methods.

According to the present invention, notifications may be provided in accordance with life cycle of events and situations of users, because it is possible to provide a situation-dependent notification by adaptively determining an event notification generation option, a notification generation time, a notification content, a task according to the notification, or a notification recipient, depending on the situation.

Moreover, according to the present invention, a user may manage schedule more conveniently because the user does not have to specify notification generation options or notification generation times of a plurality of events included in the schedule, one by one.

### BRIEF DESCRIPTION OF THE DRAWINGS

FIG. 1 schematically shows the configuration of an overall system for managing schedule according to one embodiment of the present invention.

FIG. 2 illustratively shows the internal configuration of a schedule management system according to one embodiment of the present invention.

FIG. 3 illustratively shows a procedure of providing notifications on schedule according to one embodiment of the present invention.

FIG. 4A and 4B illustratively show screens in which notifications are provided according to one embodiment of the present invention.

FIG. 5 illustratively shows screens in which additional features for notifications are provided according to one embodiment of the present invention.

### DETAILED DESCRIPTION OF THE EMBODIMENTS

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures, and characteristics described herein may be implemented as modified from one embodiment to another without departing from the spirit and scope of the invention. Furthermore, it shall be understood that the locations or arrangements of individual components within each of the disclosed embodiments may also be modified without departing from the spirit and scope of the invention. Therefore, the following detailed description is not to be taken in a limiting sense, and the scope of the invention, if properly described, is limited only by the appended claims and all equivalents thereof. In the drawings, like reference numerals refer to the same or similar functions throughout the several views.

Hereinafter, preferred embodiments of the present invention will be described in detail with reference to the accompanying drawings to enable those skilled in the art to easily implement the invention.

### Configuration of Overall System

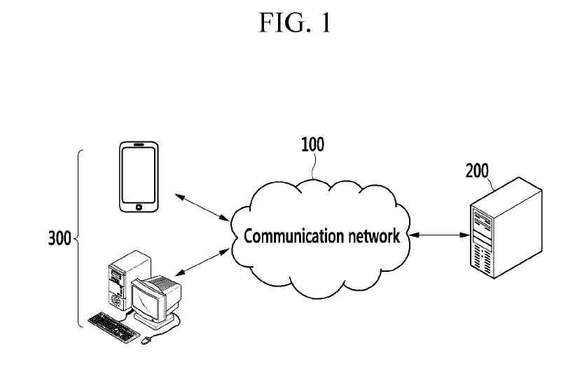

FIG. 1 schematically shows the configuration of an overall system for managing schedule according to one embodiment of the present invention.

As illustrated in FIG. 1, the overall system according to one embodiment of the present invention may include a communication network 100, a schedule management system 200, and user terminal devices 300.

First, the communication network 100 according to one embodiment of the present invention may be configured regardless of communication modality such as wired and wireless communications, and may be configured as a variety of communication networks such as local area networks (LANs), metropolitan area networks (MANs), and wide area networks (WANs). Preferably, the communication network 100 described herein may be the Internet or World Wide Web (WWW). However, the communication network 100 is not necessarily limited thereto, and may at least partially include a well-known wired/wireless data communication network, a well-known telephone network, or a well-known wired/wireless television communication network.

Next, the schedule management system 200 according to one embodiment of the present invention may function to provide a situation-dependent notification by adaptively determining an event notification generation option, a notification generation time, a notification content, a task according to the notification, or a notification recipient, depending on the situation, by selecting at least one event requiring a notification from among events included in a user's schedule, dynamically determining a notification generation option, a notification generation time, a notification content, a task according to the notification, or a notification recipient of the at least one selected event with reference to context information for generation of the notification, and generating the notification of the event whose notification is determined to be generated, with reference to the notification generation time, the notification content, the task according to the notification, or the notification recipient determined as above.

The configuration and function of the schedule management system 200 according to the present invention will be discussed in detail in the following detailed description.

The user terminal device 300 according to one embodiment of the present invention is digital equipment capable of allowing a user to connect to and communicate with the schedule management system 200. Any digital equipment may be employed as the user terminal device 300 according to the present invention as long as it has a memory means and a microprocessor for computing capabilities, like smartphones, tablets, desktop computers, laptops, workstations, PDAs, web pads, mobile phones, etc.

Particularly, the user terminal device 300 may include an application (not shown) that supports the provision of services to the user from the schedule management system 200. This application may be downloaded from the schedule management system 200 or a well-known web server (not shown). Obviously, the application may be provided by implementing a calendar GUI for a conventional calendar program (e.g., a calendar GUI for schedule management in Microsoft Outlook), as necessary. At least part of information for configuring such a calendar GUI may be information received from the schedule management system 200.

### Configuration of Schedule Management System

Hereinafter, the internal configuration of the schedule management system crucial for implementing the present invention and the functions of the respective components thereof will be discussed.

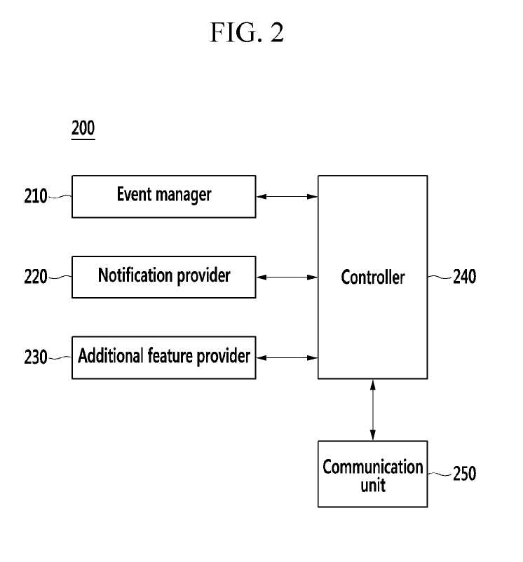

FIG. 2 illustratively shows the internal configuration of the schedule management system according to one embodiment of the present invention.

Referring to FIG. 2, the schedule management system 200 according to one embodiment of the present invention may include an event manager 210, a notification provider 220, an additional feature provider 230, a communication unit 240, and a controller 250. According to one embodiment of the present invention, at least some of the event manager 210, the notification provider 220, the additional feature provider 230, the communication unit 240, and the controller 250 may be program modules that communicate with an external system (not shown). The program modules may be included in the schedule management system 200, in the form of operating systems, application program modules, or other program modules. Physically, they may be stored in various well-known storage devices. Further, the program modules may also be stored in a remote storage device capable of communicating with the schedule management system 200. These program modules may encompass, but are not limited to, routines, subroutines, programs, objects, components, data structures, etc. for performing particular tasks or executing particular abstract data types to be described later in accordance with the invention.

First, according to one embodiment of the present invention, the event manager 210 may function to select at least one event requiring a notification from among events included in a user's schedule. Specifically, the event manager 210 according to one embodiment of the present invention may specify a predetermined rule based on the type of an event or whether other users attend the event or not, and may select at least one event requiring a notification by applying the specified rule to the event.

Next, according to one embodiment of the present invention, the notification provider 220 may function to dynamically determine a notification generation option, a notification generation time, a notification content, a task according to the notification, or a notification recipient of the at least one selected event requiring the notification, with reference to context information for generation of the notification. Moreover, the notification provider 220 according to one embodiment of the present invention may function to dynamically determine a task according to the notification, that is, a task to be done by the user in association with the notification upon receipt thereof (for example, to set off right now, travel by subway, etc.), with reference to the context information for generation of the notification.

Here, according to one embodiment of the present invention, the context information for generation of the notification may include information on a local time zone of the user, information on a current time, information on the user's current location, information on traffic conditions, information on the user's behavioral patterns, demographic information of the user, information on an event organizer, information on priorities of event attendees, information on the time and location of the event, and so on.

Further, according to one embodiment of the present invention, the information on the user's behavioral patterns may include information on transportation means or travel routes preferred by the user, information on a travel time to a location of an event most recently registered by the user, information on the user's pattern of event registration, information on the user's frequencies of event registration by attendees or event types, information on hours or places preferred by the user, information on event types preferred by the user, information on other users preferred by the user, information on the user's activities on social networking services (SNS), information on the context of chats the user has had with other users, and so on.

For example, if the time left from the present time until the start of an event is somewhat longer than or equal to that expected to be taken for the user to travel from the current location to the location of the event, it may be determined that a notification saying, “It's time to leave.” is provided to the user. For another example, if the time left from the present time until the start of the event is shorter than that expected to be taken for the user to travel from the current location to the location of the event, it may be determined that a notification saying, “Might be late.” is provided to the user. For yet another example, if the user is expected to be late for the event, the expected time of the user's arrival may be calculated in real time, based on information on the user's current location, real-time traffic conditions, and so on. Depending on the expected arrival time, it may be determined that a notification saying more details, like “Might be around 5 minutes late.” is provided to the user.

Moreover, according to one embodiment of the present invention, the notification provider 220 may function to generate a notification of an event whose notification is determined to be generated according to the above dynamic determination procedure, with reference to the notification generation time, the notification content, or the notification recipient. Additionally, the notification provider 220 according to one embodiment of the present invention may function to provide information on the task to be done by the user in association with the notification provided as above. This information may be provided through a user interface like a one-click button easily accessible to the user.

Specifically, the notification provider 220 according to one embodiment of the present invention may provide a notification not only to the user who has registered the event on the users schedule, but also to other users who are to attend the event. The notification provided to the other users may include information on the user's current location, expected arrival time, and so on. For example, if the locations of attendees are monitored every minute from 10 minutes before the start of the event, and a first attendee is determined to have come near the location of the event, then a notification that the first attendee has almost arrived at the location of the event may be provided to the attendees other than the first attendee. Thereby, the event inviter may have enough time to, for example, prepare for a reception or travel to the location of the event, and the event invitees may have the convenience of not having to notify that they have arrived at at the location of the event.

If the user is determined to be in a situation inappropriate for receiving a notification, with reference to context information for generation of the notification, then the notification provider 220 according to one embodiment of the present invention may generate no notification for the user, or may generate a notification without disturbances such as sound or vibration. For example, depending on a time zone in which the user is located (e.g., night-time hours), hours in which the user is assumed to be driving, or hours in which the user is assumed to be attending other events, no notification may be generated, or a notification without disturbances such as sound or vibration may be generated.

Next, according to one embodiment of the present invention, the additional feature provider 230 may function to provide various additional features in association with an event to be notified.

Specifically, the additional feature provider 230 according to one embodiment of the present invention may support the creation of a subsequent event that will take place following the current event. For example, provided that a lunch event is taking place with several users in attendance, those users attending the event may be recommended a subsequent event that will take place in a coffee shop near the location of the event. For another example, provided that a dinner event is taking place with several users in attendance, those users attending the event may be recommended a subsequent event that will take place in a dessert cafe, a bar, or a pub near the location of the event. Here, the notification provider 220 according to one embodiment of the present invention may provide a notification containing a recommendation for the above subsequent event to the users attending the current event. This enables a user to easily arrange a subsequent event associated with a current event.

Moreover, the additional feature provider 230 according to one embodiment of the present invention may function to allow information created in an event (i.e., an event log) to be shared between users who have attended the event, within a predetermined period of time after the end of the event. For example, when a business meeting event is ended, information such as name cards of attendees or minutes of the meeting may be shared between the attendees immediately after the end of the event. Here, the notification provider 220 according to one embodiment of the present invention may provide a notification for sharing of the event log to the users who have attended the event. The attendees, upon receiving this notification, may perform sharing activities like sending information such as the name cards in their possession or the minutes of the meeting to terminal devices of the other attendees or a server.

In addition, the additional feature provider 230 according to one embodiment of the present invention may function to collect information on responses of attendees who are invited to an event (i.e., who receive invitations from an inviter of the event) and to provide the inviter with information on pending status of the invitations, based on the collected information on the responses of the attendees. Here, the notification provider 220 according to one embodiment of the present invention may function to provide a notification about the pending status of the invitations to a user who is the inviter.

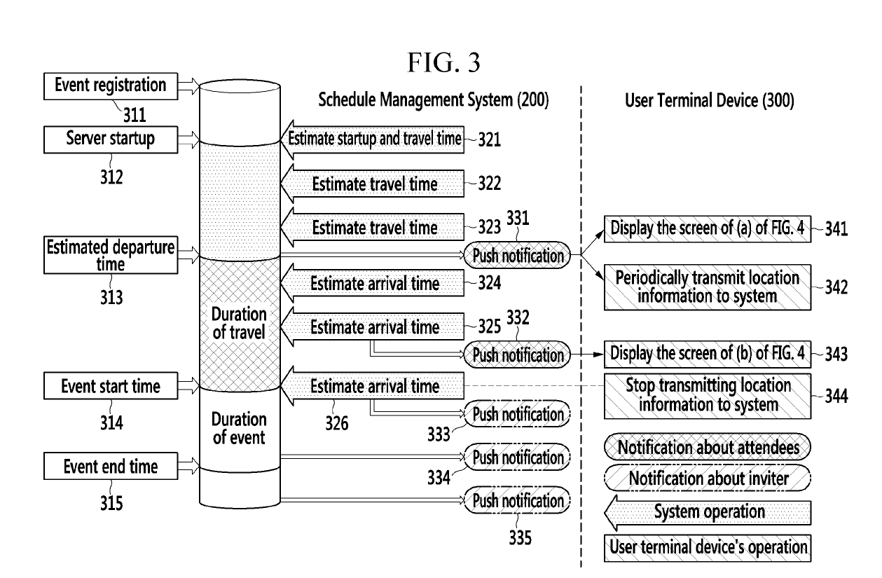

FIG. 3 illustratively shows a procedure of providing notifications on schedule according to one embodiment of the present invention. In FIG. 3, it is assumed that a user attends an event taking place at a remote place located away from the user's location at a predetermined distance.

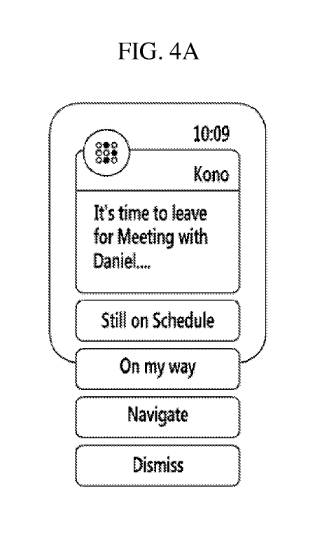

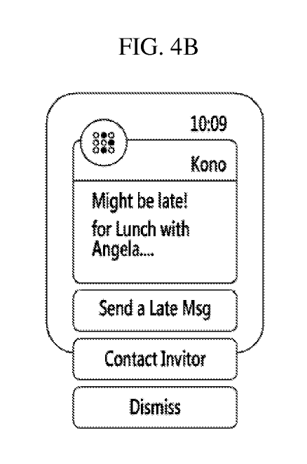

Referring to FIG. 3, when the user who is the event attendee registers the event on the user's schedule (311) and then the schedule management system 200 is started (312), the schedule management system 200 may periodically estimate the time expected to be taken for the user to travel from the current location to the location of the event (i.e., travel time) (321 to 323). If the estimated travel time is somewhat shorter than or equal to the time left from the present time until the start of the event, a push notification saying, “It's time to leave.” may be provided to the terminal device 300 of the user (331). The user terminal device 300, upon receiving the push notification, may display a notification provision screen as illustrated in FIG. 4A (341), and may periodically transmit its location information (e.g., GPS information) to the schedule management system 200 (342).

Next, referring to FIG. 3, if the estimated travel time is longer than the time left from the present time until the start of the event (324 and 325), the schedule management system 200 may provide a push notification saying, “Might be late.” to the terminal device 300 of the user (332). The user terminal device 300, upon receiving the push notification, may display a notification provision screen as illustrated in FIG. 4B (343).

Next, referring to FIG. 3, when the user who is the event attendee has almost arrived at the location of the event around the start time of the event (314), the schedule management system 200 may provide a push notification saying, “Attendee has almost arrived.” to the terminal device 300 of the user who is the event inviter (333). In this case, the terminal device 300 of the user who is the event attendee may stop transmitting its location information (e.g., GPS information) to the schedule management system 200 (344).

Next, referring to FIG. 3, the schedule management system 200 may provide the user terminal device 300 of the event attendee or the event inviter with a push notification saying, “Suggestion for after-meeting” to suggest the creation of a subsequent event while the event is taking place.

Next, referring to FIG. 3, after the event is ended (315), the schedule management system 200 may provide a push notification saying, “It's time to share meeting log.” to the user terminal device 300 of the event attendee or the event inviter, so that information on an event log created in the event may be shared between the users who have attended the event.

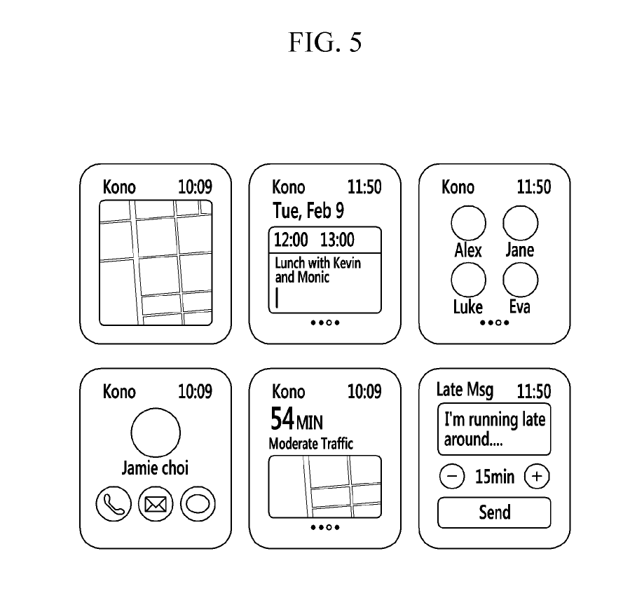

FIG. 4A and 4B illustratively show screens in which notifications are provided according to one embodiment of the present invention. FIG. 5 illustratively shows screens in which additional features for notifications are provided according to one embodiment of the present invention.

First, referring to FIG. 4A, a notification screen saying, “It's time to leave.” may be displayed on the user terminal device 300, and various graphic elements linked to additional features may be further displayed together with the notification screen. For example, there may be displayed graphic elements such as “Still on schedule” corresponding to an additional feature for keeping an event on the schedule, “On my way” corresponding to an additional feature for assisting a user to enter information on a situation in which the user is already on the way to an event location, “Navigate” corresponding to an additional feature for navigating the user to the event location, and “Dismiss” corresponding to an additional feature for dismissing the notification.

Next, referring to FIG. 4B, a notification screen saying, “Might be late.” may be displayed on the user terminal device 300, and various graphic elements linked to additional features may be further displayed together with the notification screen. For example, there may be displayed graphic elements such as “Send a late msg” corresponding to an additional feature for assisting a user to send a late message to other users who are to attend an event, “Contact Inviter” corresponding to an additional feature for supporting connection between an event attendee and an event inviter, and “Dismiss” corresponding to an additional feature for dismissing the notification.

Next, referring to FIG. 5, there can be seen screens in which additional features such as View Map, Event Details, Attendee Profiles, Contact Inviter, Estimated Travel Time, and Send Message are provided on the user terminal device 300.

Meanwhile, the communication unit 240 according to one embodiment of the present invention may function to allow the schedule management system 200 to communicate with an external device such as the user terminal device 300.

Lastly, the controller 250 according to one embodiment of the present invention may function to control the flow of data among the event manager 210, the notification provider 220, the additional feature provider 230, and the communication unit 240. That is, the controller 250 may control inbound data flow or data flow among the respective components of the schedule management system 200 such that the event manager 210, the notification provider 220, the additional feature provider 230, and the communication unit 240 may carry out their particular functions, respectively.

The embodiments according to the present invention described above may be implemented in the form of program instructions that can be executed by various computer components, and may be stored on a non-transitory computer-readable recording medium. The non-transitory computer-readable recording medium may include program instructions, data files, data structures, and the like individually or in combination. The program instructions stored on the non-transitory computer-readable recording medium may be specifically designed and configured for the present invention, or may also be known and available to those skilled in the computer software field. Examples of the non-transitory computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

In the foregoing discussion, although the present invention has been described in connection with specific matters such as detailed components as well as the limited embodiments and the drawings, they are only provided to help more general understanding of the present invention, and the present invention is not limited to the above embodiments. It will be appreciated by those skilled in the art that various modifications and changes may be made from the above description.

Therefore, the spirit of the present invention should not be limited to the above-described embodiments, and the entire scope of the appended claims and their equivalents will be considered to fall within the scope and spirit of the present invention.

What is claimed is:

1. A method for providing notifications on schedule, comprising the steps of:
selecting at least one event requiring a notification from among events included in a user's schedule;
dynamically determining at least one of a notification generation option, a notification generation time, a notification content, a task listed in the notification, and a notification recipient of the at least one selected event, with reference to context information for generation of the notification; and
generating the notification of the event whose notification is determined to be generated, with reference to the determined at least one of the notification generation time, the notification content, the task according to the notification, and the notification recipient.

2. The method of claim 1, wherein the context information comprises at least one of information on a local time zone of the user, information on a current time, information on the user's current location, information on traffic conditions, information on the user's behavioral patterns, demographic information of the user, information on an event organizer, information on priorities of event attendees, and information on a time or location of the event.

3. The method of claim 2, wherein the information on the user's behavioral patterns comprises at least one of information on transportation means or travel routes preferred by the user, information on a travel time to a location of an event most recently registered by the user, information on the user's pattern of event registration, information on the user's frequencies of event registration by attendees or event types, information on hours or places preferred by the user, information on event types preferred by the user, information on other users preferred by the user, information on the user's activities on social networking services (SNS), and information on the context of chats the user has had with other users.

4. The method of claim 1, wherein, in the step of generating the notification, a notification about at least one of the user's location and the user's estimated time of arrival is provided to other users attending the at least one selected event.

5. The method of claim 1, wherein, in the step of generating the notification, a notification for recommending at least one subsequent event associated with the at least one selected event is generated.

6. The method of claim 1, wherein, in the step of generating the notification, a notification for notifying that information created in the at least one selected event is to be shared between users who have attended the at least one selected event is generated.

7. The method of claim 1, wherein, in the step of generating the notification, a notification containing information on the user's response to an invitation to the at least one selected event is provided.

8. A non-transitory computer-readable recording medium for storing a computer program for executing the method of claim 1.

9. A system for providing notifications on schedule, comprising:
an event manager for selecting at least one event requiring a notification from among events included in a user's schedule; and
a notification provider for dynamically determining at least one of a notification generation option, a notification generation time, a notification content, a task according to the notification, and a notification recipient of the at least one selected event, with reference to context information for generation of the notification, and generating the notification of the event whose notification is determined to be generated, with reference to the determined at least one of the notification generation time, the notification content, the task according to the notification, and the notification recipient.

10. The system of claim 9, wherein the context information comprises at least one of information on a local time zone of the user, information on a current time, information on the user's current location, information on traffic conditions, information on the user's behavioral patterns, demographic information of the user, information on an event organizer, information on priorities of event attendees, and information on a time or location of the event.

11. The system of claim 10, wherein the information on the user's behavioral patterns comprises at least one of information on transportation means or travel routes preferred by the user, information on a travel time to a location of an event most recently registered by the user, information on the user's pattern of event registration, information on the user's frequencies of event registration by attendees or event types, information on hours or places preferred by the user, information on event types preferred by the user, information on other users preferred by the user, information on the user's activities on social networking services (SNS), and information on the context of chats the user has had with other users.

12. The system of claim 9, wherein the notification provider provides a notification about at least one of the user's location and the user's estimated time of arrival to other users attending the at least one selected event.

13. The system of claim 9, wherein the notification provider generates a notification for recommending at least one subsequent event associated with the at least one selected event.

14. The system of claim 9, wherein the notification provider generates a notification for notifying that information created in the at least one selected event is to be shared between users who have attended the at least one selected event.

15. The system of claim 9, wherein the notification provider provides a notification containing information on the user's response to an invitation to the at least one selected event.
